(19) United States
(12) Patent Application Publication
(10) Pub. No.: US 2014/0064716 A1
(43) Pub. Date: Mar. 6, 2014

(54) ELECTRIC BOILER CONTROL SYSTEM

(71) Applicant: KLOD COHEN, ZEFAT (IL)

(72) Inventor: KLOD COHEN, ZEFAT (IL)

(21) Appl. No.: 13/706,367

(22) Filed: Dec. 6, 2012

(30) Foreign Application Priority Data
Aug. 28, 2012 (IL) 221673

(51) Int. Cl. F24H 9/20

(52) U.S. Cl. CPC F24H 9/2021
USPC 392/441; 392/498

(57) ABSTRACT

An electric boiler control system, comprising: a series circuit, connected to a power supply source, said series circuit comprising: a heating element, dipped in a water of said boiler; a thermostat employing a first switch, adapted to open when a temperature of said water reaches a first level, and to close when said temperature falls under a second level, wherein said second level is less than said first level; a second switch, serially connected to said first switch; a mechanism for keeping said second switch closed while said series circuit is closed, and keeping said switch open, until closed by a user; a first button, for closing said second switch by a user; and a second button, for opening said second switch by a user.

### FIELD OF THE INVENTION

The present invention relates to the field of electric boilers. More particularly, the invention relates to an electric boiler control system, which saves electric power.

### BACKGROUND OF THE INVENTION

According to a common operation mode of a domestic electric boiler, once the temperature in the boiler has reached a certain level, the boiler maintains this temperature. Thus, once the temperature of the boiler has reached to a first temperature level (e.g., 70 degrees Celsius), the heating stops; and once the temperature is reduced to a second temperature level (which is lower than the first level, such as 60 degrees Celsius), the boiler restarts heating, until its temperature reaches the first level, and so forth.

A common problem with this mode of operation is that a user may forget to turn off the boiler after use, and as a result, electric power is wasted. Furthermore, a user may forget to turn off the boiler during a time he is away from his house, e.g., for a vacation, which might end in waste of a considerable amount of electric power.

It is an object of the present invention to provide a solution to the above-mentioned and other problems of the prior art.

Other objects and advantages of the invention will become apparent as the description proceeds.

### SUMMARY OF THE INVENTION

The term “closed circuit” refers herein to an electric circuit providing an uninterrupted, endless path for the flow of current.

The term “open circuit” refers herein to an incomplete electrical circuit in which no current flows.

An electric boiler control system, comprising:

a series circuit (10), connected to a power supply source (50, 52), said series circuit (10) comprising:
a heating element (62), dipped in a water of said boiler (12);
a thermostat (64) employing a first switch (40), adapted to open when a temperature of said water reaches to a first level, and to close when said temperature falls under a second level, wherein said second level is less than said first level;
a second switch (70), serially connected to said first switch (40);
a mechanism (80) for keeping said second switch (70) closed while said series circuit (10) is closed, and keeping said switch (70) open, until being closed by a user;
a first button (16), for closing said second switch (70) by a user; and
a second button (18), for opening said second switch (70) by a user; thereby upon opening said series circuit (10) by said first switch (40), retaining said series circuit (10) open until manually closed by said second switch (70).

According to one embodiment of the invention, said mechanism (80) comprises:
an electromagnet (20), connected serially to said series circuit (10);
a swing (30), comprising a first arm (32) and a second arm (34), wherein said second arm (34) is drawable by said electromagnet (20) in one direction; and
a spring (38), for drawing said swing (30) to an opposite direction to said one direction,
wherein a drawing power of said electromagnet (20) is greater than a drawing power of said spring (38).

According to one embodiment of the invention, the mechanism (80) is installed in a control box installed inside a domestic wall.

According to another embodiment of the invention, the mechanism (80) is installed in a control box at a surface of a domestic wall.

The mechanism (80) may be implemented by an integrated circuit employing a relay, a computerized mechanism employing a relay, and so on.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF THE DRAWINGS

Embodiments and features of the present invention are described herein in conjunction with the following drawings:

FIG. 1 schematically illustrates a domestic boiler controlled by an electric control system, according to one embodiment of the invention.

FIG. 2 further details the control box 14 of FIG. 1.

Each of FIGS. 3a, 3b and 3c schematically illustrates a state of a control system of a domestic boiler, according to one embodiment of the invention.

FIG. 4 is an exploded view of the control box 14 of the control system of FIGS. 1, 2 and 3a, 3b, and 3c.

FIG. 5 is a sectioned view thereof.

It should be understood that the drawings are not necessarily drawn to scale.

### DETAILED DESCRIPTION OF THE INVENTION

The present invention will be understood from the following detailed description of preferred embodiments, which are meant to be descriptive and not limiting. For the sake of brevity, some well-known features, methods, systems, procedures, components, circuits, and so on, are not described in detail.

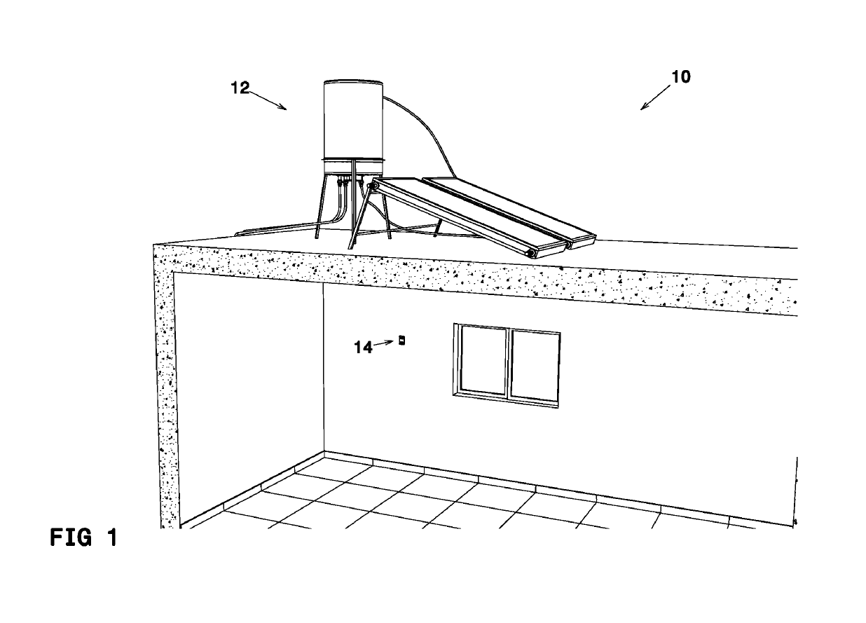

FIG. 1 schematically illustrates a domestic boiler controlled by an electric control system, according to one embodiment of the invention.

The electric control system is installed in the interior side of a domestic residence, in a control box 14.

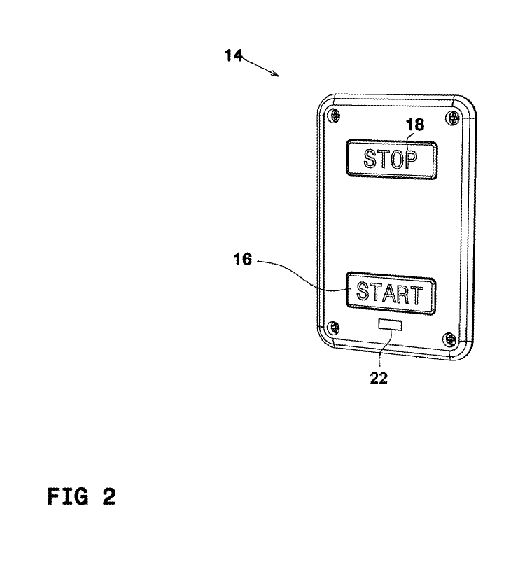

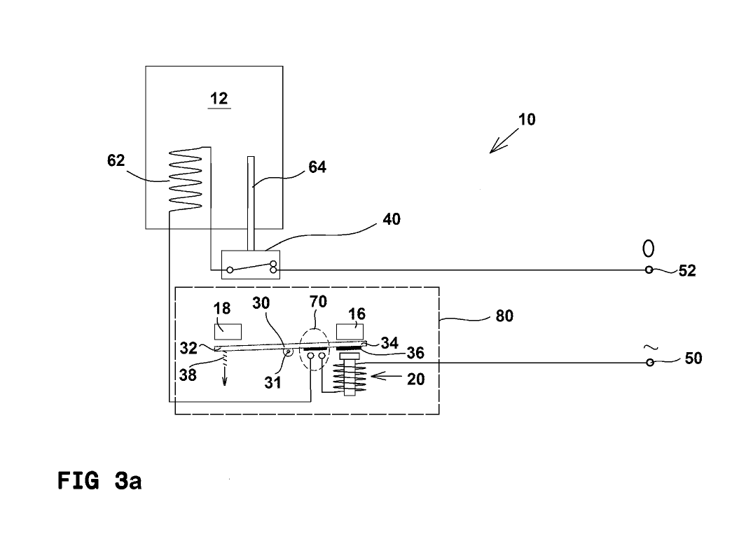

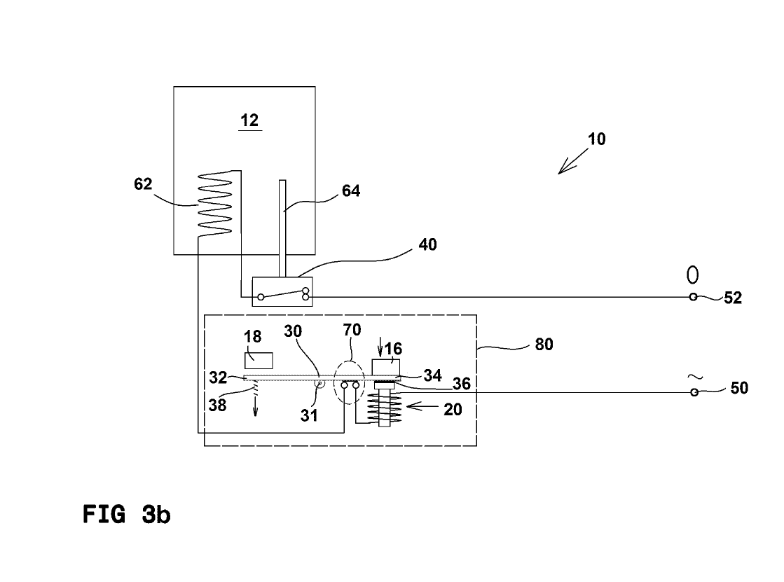

FIG. 2 further details the control box 14 of FIG. 1.

The control box 14 comprises two push buttons, 16 and 18. Button 16, the START button, is used for connecting boiler 12 to the domestic electric power supply; and button 18, the STOP button, is used for disconnecting the boiler from the domestic electric power supply.

Reference numeral 22 denotes a LED indicating that the boiler is currently heated.

After the boiler has been connected to the domestic electric power supply by pressing button 16, once the boiler temperature reaches a desired level, the control system disconnects the boiler from the domestic electric power supply, and does not turn it on until the START button 16 is repressed.

The STOP button 18 is used for manually disconnecting the boiler from the domestic power supply.

Each of FIGS. 3a, 3b and 3c schematically illustrates a state of a control system of a domestic boiler, according to one embodiment of the invention.

FIG. 3a illustrates the system in an idle state; FIG. 3b illustrates the system while being activated by a user by pressing button 16; and FIG. 3c illustrates the system after the user leaves button 16. As can be seen from FIG. 3c, button 16 returns to its normal position, i.e., away from arm 34.

The system comprises a series circuit 10 which passes from contact 50, through electromagnet 20, through switch 70, through heating element 62 of the boiler, through switch 40, up to contact 52.

The system also comprises a thermostat 64 that includes a switch 40, which is also referred to herein as a first switch.

A mechanism 80 of the control circuit 10 causes switch 70 (which is also referred to herein as a second switch) to open when the series circuit 10 is open and to keep switch 70 open until a user closes switch 70.

More specifically, circuit 10 employs two switches, 40 and 70. As long as both switches are closed, a current is supplied to heating element 62. Thus, once switch 40 opens, switch 70 opens as well, and no electric power supply is provided until a user presses button 16.

More specifically, in boiler 12 is installed a heating element 62, and a thermostat 64. The thermostat employs a switch 40 which opens the power passing therethrough when the boiler's water temperature reaches a first level (e.g., 70 degrees Celsius), and closes switch 40 when the temperature goes below a second level (lower than the first level, such as 60 degrees Celsius). This is a prior art mechanism.

According to one embodiment of the invention, the following mechanism 80 is added to the power supply circuit of the boiler:

The mechanism uses a swing-like element 30, wherein one arm thereof is marked by reference numeral 32, and the other arm is marked by reference numeral 34. The hinge thereof (on which the element swings) is marked by reference numeral 31.

Arm 34 also comprises a ferrite element 36 attached thereto, and arm 32 also comprises a spring 38 which pulls arm 32 in the direction illustrated by the arrow.

The mechanism also comprises an electromagnet 20, which pulls arm 34 in the opposite direction of spring 38. Thus, while electromagnet 20 pulls arm 34 in one direction, spring 38 pulls the other arm 32 in the same direction.

It should be noted that the power of electromagnet 20 is higher than that of spring 38. Thus, when no current passes through electromagnet 20, spring 38 draws arm 34 away from the electromagnet, as illustrated in FIG. 3a.

Reference numeral 70 denotes a switch operated by arm 34. When arm 34 is pulled to electromagnet 20, as illustrated in FIG. 3b, switch 70 gets closed; when arm 34 is not pulled by the electromagnet, switch 70 gets open.

If both switches 70 and 40 are closed, current is passing through electromagnet 20, resulting in pulling ferrite 36 of arm 34 by electromagnet 20, and thereby keeping switch 70 closed, as long as the series circuit remains closed.

It should be noted that a single circuit passes from contact 50, through electromagnet 20, through switch 70, through heating element 62, through switch 40, up to contact 52. Thus, assuming the circuit is closed, once it gets open (as a result of disconnecting the circuit by switch 40), the power to the electromagnet is ceased, and therefore the circuit will remain open even if switch 40 closes again.

In order to close the series circuit 10, button 16 must be pressed. In this situation, the circuit remains closed until switch 40 opens. Once switch 40 has opened, the circuit can be closed again only by a user pressing button 16.

Button 18 is used to open the circuit, by drawing arm 34 away from the electromagnet, thereby opening switch 70. As no current is in series circuit 10, it remains open, regardless of the situation of switch 40.

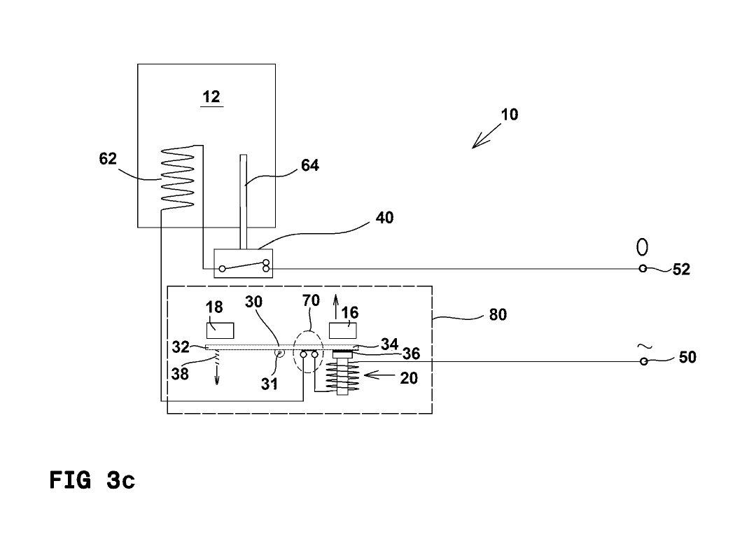

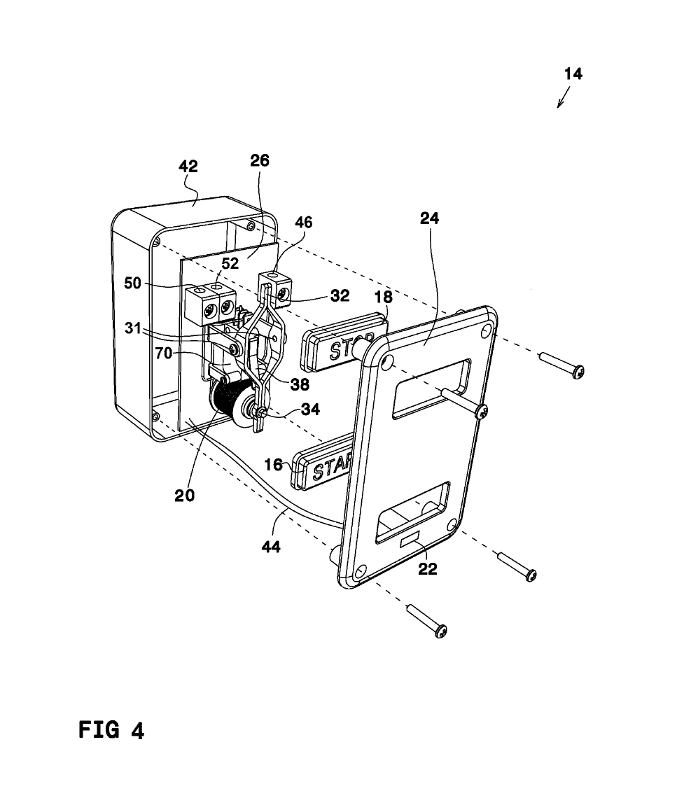

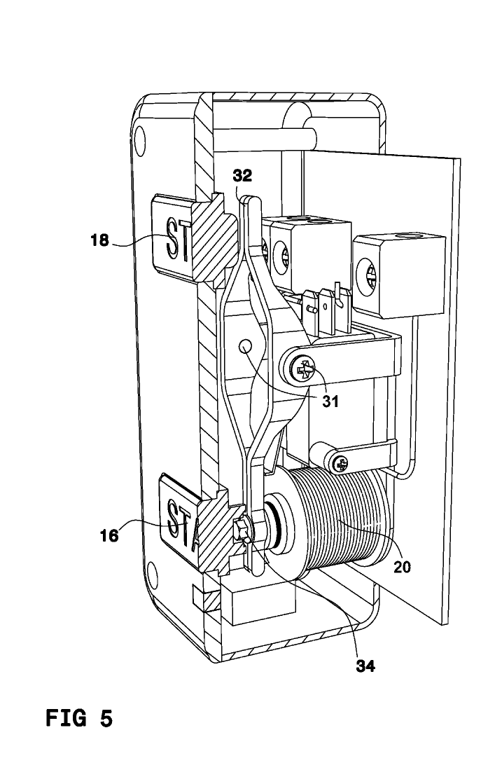

FIG. 4 is an exploded view of the control box 14 of the control system of FIGS. 1, 2 and 3a, 3b, and 3c, and FIG. 5 is a sectioned view thereof.

The control system is installed in a casing 42, having a top 24, which comprises buttons 16 and 18, and an indication LED 22.

Contacts 50 and 52 are installed in an electric circuit board 26. The electric circuit board also comprises a contact 46, which connects to heating element 62 of the boiler. Wires 44 connect between the elements installed on top 24 and the elements of the electric circuit board 26.

It should be noted that the casing can be installed in a hole inside a domestic wall, as well as on the wall's surface.

Of course, as any electric control circuit can be replaced by an integrated circuit, the above described circuit 10 can also be implemented by integrated circuitry, by a computerized mechanism (memory and CPU executing a code), by an electronic circuit employing logical gates, employing relays with each of these options, and so on.

In the figures and/or description herein, the following reference numerals have been mentioned:
numeral 10 denotes a series circuit controlling an electric boiler, according to one embodiment of the invention;
numeral 12 denotes a boiler;
numeral 14 denotes a control box;
numeral 16 denotes a START button (also referred to as “first button”);
numeral 18 denotes a STOP button (also referred to as “second button”);
numeral 20 denotes an electromagnet;
numeral 22 denotes a LED (Light Emitting Diode) indicating that the boiler is currently heated;
numeral 24 is a top of control box 14;
numeral 26 is an electric circuit board of control box 14;
numeral 30 is a swing-like element;
numeral 31 is a hinge of swing 30;
numeral 32 is one arm of swing 30;
numeral 34 is the other arm of swing 30;
numeral 36 is a ferrite element attached to arm 34;
numeral 38 denotes a spring drawing arm 32;
numeral 40 is a first switch that opens circuit 10 when the boiler's water temperature reaches a first level, and closes circuit 10 when this temperature falls under a second level;
numeral 42 is a casing of control box 14; numeral 44 denotes wires that connect the elements installed on top 24 to the elements of the electric circuit board 26;
numeral 50 denotes a contact of a domestic power supply source;
numeral 52 denotes another contact of the domestic power supply source;
numeral 62 denotes a heating element of boiler 12;
numeral 64 denotes a thermometer (actually thermometer 64 and switch 40 are a thermostat);
numeral 70 denotes a second switch, serially connected to the first switch 40; and reference numeral 80 denotes a mechanism for keeping the second switch 70 closed while the series circuit 10 is closed, and keeping switch 70 open, until closed by a user.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

What is claimed is:

1. An electric boiler control system, comprising:
a series circuit (10), connected to a power supply source (50, 52), said series circuit (10) comprising:
a heating element (62), dipped in a water of said boiler (12);
a thermostat (64) employing a first switch (40), adapted to open when a temperature of said water reaches a first level, and to close when said temperature falls under a second level, wherein said second level is less than said first level;
a second switch (70), serially connected to said first switch (40);
a mechanism (80) for keeping said second switch (70) closed while said series circuit (10) is closed, and keeping said switch (70) open, until closed by a user;
a first button (16), for closing said second switch (70) by a user; and
a second button (18), for opening said second switch (70) by a user;
thereby upon opening said series circuit (10) by said first switch (40), retaining said series circuit (10) open until manually closed by said second switch (70).

2. A control system according to claim 1, wherein said mechanism (80) comprises:
an electromagnet (20), connected serially to said series circuit (10);
a swing (30), comprising a first arm (32) and a second arm (34), wherein said second arm (34) is drawable by said electromagnet (20) in one direction; and
a spring (38), for drawing said swing (30) to an opposite direction from said one direction,
wherein a drawing power of said electromagnet (20) is greater than a drawing power of said spring (38).

3. A control system according to claim 1, wherein said mechanism (80) is installed in control box disposed in a domestic wall.

4. A control system according to claim 1, wherein said mechanism (80) is installed at a surface of a domestic wall.

5. A control system according to claim 1, wherein said mechanism (80) is implemented by an integrated circuit employing a relay.

6. A control system according to claim 1, wherein said mechanism (80) is implemented by a computerized mechanism employing a relay.
